(19) United States
(12) Patent Application Publication
(10) Pub. No.: US 2017/0139475 A1
(43) Pub. Date: May 18, 2017

(54) Method and apparatus for tracking user gaze and adapting content

(71) Applicant: Viomba Oy, Helsinki (FI)

(72) Inventors: Shahram Eivazi, Helsinki (FI); Tersia Gowases, Helsinki (FI)

(21) Appl. No.: 14/940,185

(22) Filed: Nov. 13, 2015

(51) Int. Cl. G06F 3/01; G06F 3/0482; G06F 3/16; G06F 17/22; G06F 3/0484

(52) U.S. Cl. CPC G06F 3/013; G06F 17/2247; G06F 17/2235; G06F 3/04842; G06F 3/16; G06F 3/0482; G06F 3/04845

(57) ABSTRACT

An apparatus and method for tracking an indication of user gaze and modifying the presentation of information based on the indication of user gaze. The modification may be performed for an individual user as directed by an individual user's gaze or based upon a tracking of many users' gaze.

### FIELD OF INVENTION

The present invention relates to the tracking of user gaze and modification of items based at least partially on the tracked user gaze.

### BACKGROUND OF INVENTION

There are many methods for providing input to a computer. Keyboards may be used to provide character inputs and facilitate creation of word documents. Mice have been used to provide indication of area of interest and interaction with a simulated environment.

Various fields have used gaze tracking to record eye movements and gaze direction. Psychologists and researchers have used gaze tracking as a means to infer where a person's visual attention is directed. In addition to being a diagnostic tool, gaze tracking can also be a useful control instrument.

Gaze tracking as a control instrument can be used as a replacement for a computer mouse. The gaze tracking thus replaces the mouse as manipulator of a computer Cursor.

Furthermore, gaze tracking may be used in coordination with a memory or recording device to provide information on what the user spent time looking at, what the user first looked at, and other metrics associated with user gaze.

### SUMMARY OF THE INVENTION

The invention is defined by the features of the independent claims. Some specific embodiments are defined in the dependent claims.

According to a first aspect of the present invention, there is provided an apparatus comprising at least one processor and at least one memory including computer program code. The at least one memory and the computer program code configured to, with the at least one processor, cause the apparatus at least to: receive at least one indication of user gaze, and based at least in part on the at least one indication of user gaze, cause a presentation of at least one item comprised in a plurality of items to be modified or performed.

According to a second aspect of the present invention, there is provided a method comprising the steps of: receiving at least one indication of user gaze, and based at least in part on the at least one indication of user gaze, cause a presentation of at least one item comprised in a plurality of items to be modified or performed.

According to a third aspect of the present invention there is provided an apparatus comprising: means for receiving at least one indication of user gaze, and means for causing, based at least in part on the at least one indication of user gaze, a presentation of at least one item comprised in a plurality of items to be modified or performed.

### BRIEF DESCRIPTION OF THE DRAWINGS

FIG. 1 illustrates an example apparatus capable of support at least some embodiments of the present invention.

FIG. 2 illustrates an example of gaze tracking parameters.

FIG. 3 illustrates an example of gaze tracking as applied to example items.

FIG. 4 illustrates interactions in at least some embodiments of the present invention.

### DETAILED DESCRIPTION OF EXAMPLE EMBODIMENTS

Description is provided below of exemplary embodiments of a method and apparatus for the utilization of user gaze for the modification of items. These items may include: webpages, documents, pictures or any number of visual representations. This utilization of user gaze for modification of items may provide many benefits, including, but not limited to, at least one of: enhanced ease of access, modification of items based on user interest, modification of prominence based on user gaze, etc.

According to certain embodiments of the invention there is provided an apparatus for the modification of presentations based at least partially on monitored gaze. According to certain examples, such apparatuses can be, for example, a personal computer, a tablet computer, cell phone, etc. Such apparatuses comprise at least one processor and at least one memory. The memory includes or is capable of including computer program code.

According to certain embodiments, the computer program code is configured to perform certain tasks with the at least one processor. These tasks may include receiving at least one indication of user gaze. User gaze refers to the action of the user of looking at something. Indications of user gaze can be gathered by any of many methods of eye tracking. Examples of user gaze include a user looking at an image for a predefined period of time. User gaze is relevant as an indication of user interest, concentration, confusion or another inferred emotional or mental state. Indications of user gaze include, but are not limited to information describing user view direction and duration, obtained by tracking.

An indication of user gaze can be determined by tracking eye movements, position and orientation. An example of a device, which can be a part of or separate from the apparatus, which is capable of determining such user gaze, would be a camera for capturing video images of the face and eyes of a user. Examples of eye-gaze trackers can be seen in U.S. Pat. Nos. 4,950,069, 5,231,674, and 5,471,542.

The apparatus may also be capable of, based at least in part on the at least one indication of user gaze, performing certain actions. Examples of possible actions include the presentation of at least one item comprised in a plurality of items. Items can be visual representations of information, for example visual representations on a webpage. Such representations could include images and/or text, for example diagrams of a process and descriptions of said process. Additional examples of items and groups of items are: listing of links to information, pictures, results of a search for information, or new articles. An example use for the presentation of items would be the presentation of news articles, in order to allow a user to remain abreast of current events. Other possible actions may include modifying the presentation of at least one item comprised in a plurality of items.

Items can be modified in a plurality of ways. Different items may also be modified in different and/or unique manners compared to similar or differing items. One type of modification is to modify the visual/presented size of an item. The modification of visual size of an item can be carried out in a variety of manners. The item itself may be modified in the computer program code or the presentation of the items may be altered.

A further possible example of such modification includes modifying the order of presentation of the modified item within a set of items. A still further example of possible modifications includes modifying an order of presentation of one or more items within a set and/or list of items. Another example of possible modification includes modifying audio presentation of the modified item. Another possible modification would be suppressing presentation of the modified item. Such modifications can be used to make certain items easier to read or view. A benefit of such modifications is that physical inputs are no longer necessary or as necessary for the improvement of ease of access to information. Another possible use of modifications would be the dynamic adaptation of a webpage based on user gaze tracking. For example, the webpage may be adapted for one user based on a history of user interest or engagement as indicated by gaze tracking.

The presentation of at least one item selected/chosen from a plurality of items may also be modified such that the prominence of an item is changed. The change of prominence can be its relative increasing, decreasing and/or changing with respect to e.g. size, location, height, color, transparency, etc. compared to at least one other item in a set and/or to a default value of the item itself Another example of possible modification includes decreasing prominence of a modified item. This modification of prominence could take place within a document for the presentation of data. An example of such a document could be a hypertext transfer protocol document. Another aspect of possible embodiments would be that the plurality of items is comprised in such a hypertext transfer protocol document. The plurality of items in such a document could be links to a further plurality of items. Modification could be performed on either the plurality of items or the links to a plurality of items.

An aspect of certain embodiments is that at least one indication of gaze comprises a plurality of indications of gaze. This plurality of indications of gaze could originate from a plurality of users. Modifications could be performed at least partially based on the indications of gaze originating from a plurality of users.

An aspect of certain embodiments is that statistical information is compiled. This statistical information could be compiled from a plurality of indications of gaze. These pluralities of indication of gaze could be sourced from a plurality of apparatuses in a plurality of locations. Modifications could be performed at least partially based on statistical information.

Examples of statistical information compiled include a percentage of users which gaze at element A and a percentage which gaze at element B. For example, 35% of users may gaze at element A while 4% of users may gaze at element B. This gaze could be tracked at an instant or as an average over time. Further statistical examples include the area which was gaze at for the majority of time.

An aspect of certain embodiments is that prominence of items is modified based at least partially on indication of gaze. Modification of prominence may be performed such that an item which is gazed at more than another item is increased and/or decreased in prominence. This modification of prominence could allow for the automated relegation of already consumed media to a position of less prominence. Likewise, an item may be elevated in prominence based on its popularity as determined by statistical information.

A further aspect of certain embodiments is that at least one indication of gaze could be derived from statistical information. Modification could also increase the prominence of one item relative to another item. Increasing the prominence of one item relative to another could be based, at least in part, on statistical information related to gaze. Examples of such tracked statistical information could include frequency, duration or other aspect of tracked gaze.

An aspect of certain embodiments allows for causing text elements to be read by a machine vocalizer. This modification of presented items would allow for great ease of access to information.

An aspect of certain embodiments of the invention is that an apparatus is further configured to request at least one indication of user gaze from a web service. This indication of user gaze could comprise information on a plurality of user gazes. Based on this indication of user gaze the apparatus could select a text from a multimedia document based at least in part on the indication of user gaze. The apparatus could further cause the presentation of the selected text to be performed by causing the selected text to be provided to a machine vocalizer. Such an indication may enable a service to present to a user with increased prominence items that have been looked at more by other users.

According to certain embodiments of the invention a method is provided for causing at least one item in a plurality of items to be modified. This method involves receiving at least one indication of user gaze. Modification may be performed based at least partially upon this at least one indication of user gaze. This method is further capable of modifying at least one item in many ways, including modifying: visual size, order of presentation or audio presentation. A further example of modification would be the suppression of presentation of at least one item. This method could cause modifications in manners previously described in this specification.

Additional embodiments of the invention include a Dynamic Content Matching System. Dynamic content matching systems provide the ability to map user events directly to a dynamic system of elements.

Content matching systems typically include, but are not limited to, three units. Firstly, a user content recorder, for example a webpage element or elements. Secondly, a user event recorder, for example a gaze tracking system as provided herein. Thirdly, a unit to map user events to user content.

Within content matching systems the most difficult component is typically the mapping unit or system. Mapping of user events to static content does not typically provide difficulties, however mapping to dynamic content presents a problem.

Contents in a dynamic system often change. For example, content may not have a fixed position, orientation, or size. This dynamic content may change these parameters rapidly. Due at least in part to these issues, it is not possible to directly map user events to a fixed position of an element.

Examples of systems can include any combination of the following units:

Concerning the first unit, an example of a user content recorder is a layout recorder configured to extract information on elements being displayed. The layout recorder may extract, as an example, the location of graphical elements that exist on a display. In order to accomplish this, the layout recorder may read the computer readable instruction of a graphical layout.

Concerning the second unit, an example of a user event recorder is an image capturing unit configured to capture a representation of the elements being displayed at a certain point in time. This may be accomplished, for example, by taking a screen capture of a display. The image capturing unit may be set to repeatedly capture representations on a predefined time interval. This time interval may be set such that the image capturing unit is effectively operating continuously.

Concerning the third unit, an example of a unit to map user events to user content comprises an event recorder configured to record a plurality of events on a display. Such events may include the position of one or more pointers. These pointers may be controlled by the user via a mouse or a gaze tracking system as described herein. Further examples of events which may be tracked by the event recorder include, scrolling, clicking, or keyboard typing. The event recorder may be adapted to further record any number of user inputs.

A fourth unit known as a mask capture unit may be configured to capture a representation of graphical data in relation to the position of a pointer or other indication of user input. The mask capture unit may, for example, capture a portion of the screen surrounding a pointer. Said pointer could be controlled by a gaze tracking system or mouse, for example. The size of the area captured by the mask capture unit may be based on an input threshold. The mask capture unit may be set to repeatedly capture representations on a predefined time interval. This time interval may be set such that the mask capture unit is effectively operating continuously.

A fifth unit is known as a memory unit. The memory unit may be configured to store the information obtained by any unit. The memory unit may then provide this information to any other unit. The memory unit may comprise magnetic, optical, solid state, holographic or other kind of data storage media.

A sixth unit, known as a change detector, may be configured to use image processing techniques to detect changes in representations from the image capture unit. The change detector may detect changes between a first and second or any number of representations from the image capture unit. The representations which the change detector processes could be retrieved from the memory unit.

A seventh unit, known as an image matching unit, may be configured to determine the location of representations from the mask capture unit relative to a display of information or elements. For example, the image matching unit may determine the location of a representation from the mask capture unit on a graphical display. The image matching unit may also determine the location of a representation from the mask capture unit on a representation from the image capture unit. After determining the position, the image matching unit stores information relative to the position. This information may also be transferred to the memory unit.

An eighth unit, known as a mapping unit, may be configured to superimpose pointer data over a representation of a graphical layout of elements.

A ninth unit, known as a viewport, may be configured to provide a graphical representation of the results of the mapping unit. The viewport may, for example, show results of the mapping unit to final users.

A tenth unit, known as a server, may be configured to save and calculate various data. The server may for example perform the functions of the memory unit. The server may be located remotely from the other units. This remote location could be facilitated through the use of a communications means. This communications means could be for example, a local area network, a wireless network, a transfer protocol.

According to certain embodiments of the invention the layout recorder, image capturing unit, event recorder and mask capture unit all work in parallel to save data into the memory unit. Applicable ones of the foregoing units may be implemented as a computing device comprising a processor, memory and suitable software stored in the memory, the processor being arranged to execute the software stored in the memory.

In still further embodiments of the invention, data from the event recorder and mask capture unit is sent to the server. This data may have been retrieved from the memory unit. In this fashion the memory unit could act as an intermediary. In the event of unreliable or slow communications with the server, the memory unit may act as a cache. In certain embodiments this cache will serve to store data locally until reliable communications are established with the server.

In certain embodiments of the invention the change detector unit compares representations from the image capture unit which have been stored in the memory unit. The change detector unit may detect whether an image viewed by a user is changed. The change detector may send a changed image to the server.

An aspect of certain embodiments of the invention is that unchanged images, as determined by the change detector, are removed from memory.

An aspect of certain embodiments of the invention is that in the event that an internet connection is slow or unavailable, an image is saved on a local machine and later, when a reliable connection to the internet is established, sent to a server.

In certain embodiments of the invention the image matching unit compares a graphical representation of elements to the representations captured by the mask capture unit. This comparison allows for the determination of the location of a pointer. The pointer may be controlled via a gaze tracking system as described herein.

An aspect of certain embodiments of the invention is that the mapping unit overlays the pointer's position data on the graphical representation of elements.

According to certain embodiments of the invention a viewport unit presents the elements to a final user. Said viewport unit may be software implemented as the portion of a webpage viewable by a user. These elements may be images or other media units. One manner in which the elements could be presented is in a time-based view which utilizes the relative position of an element container. Another manner is a display-based view in which the elements could be presented is using the relative position of a pointer or pointers.

The benefits of certain embodiments of the invention relating to content matching system include but are not limited to: an increase in accuracy, an ability to work with both dynamic and static contents, an elimination of the need for additional injection code. Still more benefits of certain embodiments of the invention include bandwidth optimization and informative visualization.

Certain embodiments of the invention may be computer readable instructions stored on a non-transitory computer readable medium that, when executed by at least one processor, cause an apparatus to at least: receive at least one indication of user gaze, and cause, based at least in part on the at least one indication of user gaze, a presentation of at least one item comprised in a plurality of items to be modified or performed.

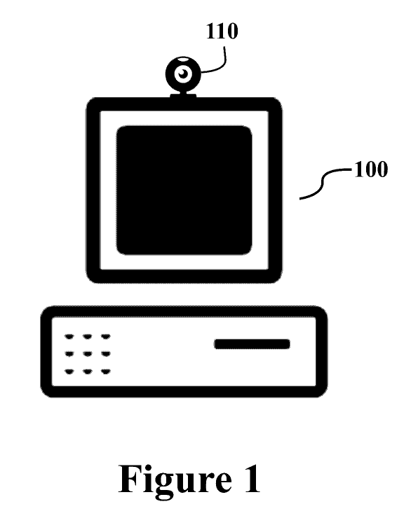

FIG. 1 illustrates an example apparatus capable of supporting at least some embodiments of the present invention. Illustrated is device 100, which may comprise, for example, a personal computer. Device 110 may comprise at least one processor and at least one memory including computer program code, the at least one memory and the computer program code being configured to, with the at least one processor, cause the apparatus to perform methods in accordance with aspects of the present invention. The processor may comprise an Intel Core or AMD Opteron processor, for example. The memory may comprise random access memory or magnetic memory, for example. Also illustrated is device 110, which may comprise, for example, a camera or cameras for capturing video images.

Device 110 may operate in conjunction with device 100 to provide video images for the purpose of gaze tracking.

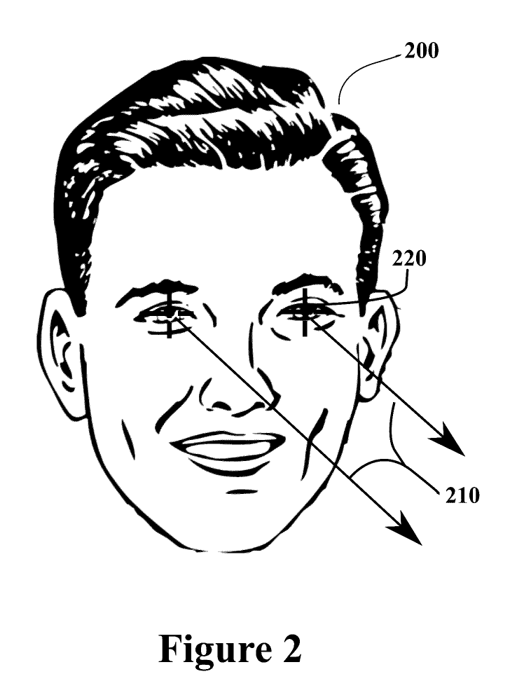

FIG. 2 illustrates an example of gaze tracking parameters as applied to a user 200. FIG. 2 may exemplify an image captured by the camera 110 of FIG. 1. Within FIG. 2 the position of the eyes of the user are monitored 220. Also monitored is the direction of gaze 210. This information may be used to provide indications of user gaze to an apparatus capable of supporting at least some embodiments of the present invention.

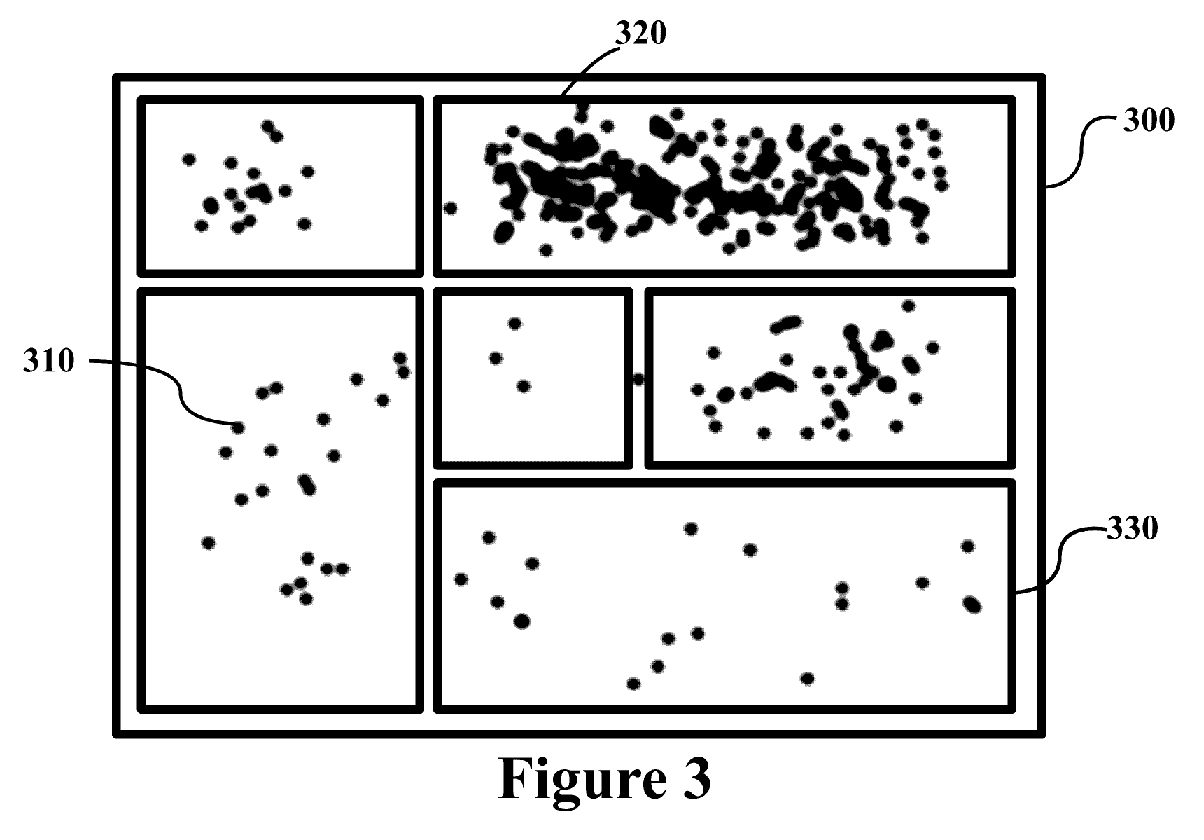

FIG. 3 illustrates an example of the tracking of user gaze across multiple items. Item 300 may represent, for example, an object for the visual presentation of items, such as a webpage. Within the webpage 300, multiple items 320, 330 may be displayed. Items could be, for example: news items, pictures, visual representations of documents or advertisements. Indications of user gaze 310 are also illustrated within FIG. 3. These indications of user gaze may be provided by the device of FIG. 1 via images as exemplified in FIG. 2.

Within FIG. 3 the indications of user gaze 310 may be compared as they correspond to different items 320 and 330. Within the example provided by FIG. 3 it may be determined that the user has gazed more at item 320 than at item 330. In at least some embodiments, indications of user gaze 310 may be collected from more than one user, wherein the more than one user may be in different locations.

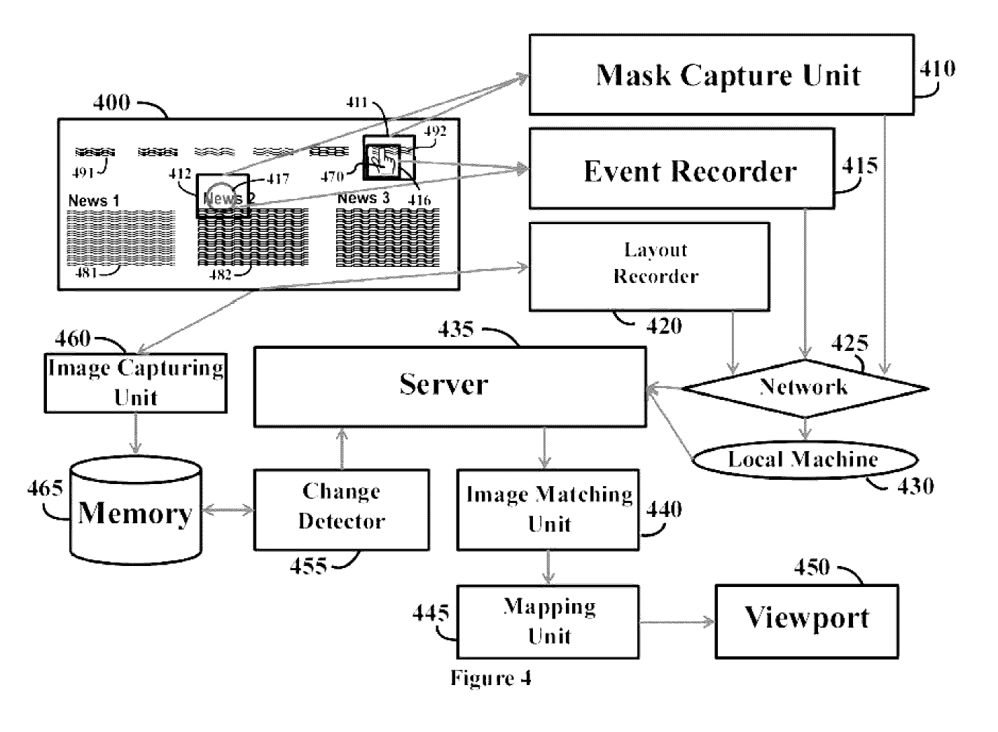

FIG. 4 illustrates interactions in at least some embodiments of the present invention. A webpage 400 is shown containing various elements. Those elements include news items 481, 482 and section headings 491, 492. The mask capture unit 410 has captured representations of at least two areas, 411 and 412. The areas correspond to two locations where the event recorder 415 has recorded events 416 and 417. Events 416 and 417 may include the position of one or more pointers. These pointers may be controlled by the user via a mouse or a gaze tracking system as described herein. Further examples of events which may be tracked by the event recorder include, scrolling, clicking, or keyboard typing. The event recorder may be adapted to further record any number of user inputs. Within these recorded events the type of event is stored along with the location of a pointer 470 at the time of the event. The layout recorder 420 has determined the layout of the webpage 400, defining the location of each element.

The mask capture unit 410, event recorder 415 and layout recorder 420 are all in communication with a local machine 430 and server 435 through a network 425. The network may include various means of local and non-local communication.

An image capturing unit 460 is capturing images of the webpage and storing them in a memory 465. The images are retrieved from memory 465 by a change detector 455 which compares images to determine which images show a change in elements and sending those images on to the server 435. The server 435 then stores images of the webpage for comparison to other inputs. Such a comparison is the use of the image matching unit 440 to determine the location of a representation captured by the mask capture unit on an image captured by the image capture unit 460. After the location of a representation from the mask capture unit 410 on a saved image of the webpage 400 is determined the mapping unit 445 can determine the location of the pointer 470. This information can then be transferred to a viewport 450 along with other information to provide a visualization of the tracked events and pointer positions.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. An apparatus comprising:
at least one processor, and
at least one memory including computer program code; the at least one memory and the computer program code configured to, with the at least one processor, cause the apparatus at least to:
receive at least one indication of user gaze, and
based at least in part on the at least one indication of user gaze, cause a presentation of at least one item comprised in a plurality of items to be modified or performed.

2. The apparatus according to claim 1, wherein the modifying of the presentation comprises at least one of modifying a visual size of the at least one item, modifying an order of presentation, modifying an audio presentation of the at least one item and suppressing presentation of the at least one item.

3. The apparatus according to claim 1, wherein the modifying of the presentation comprises modifying a hypertext transfer protocol document to, at least one of
increase prominence of a first item among the plurality of items, and
decrease prominence of a second item among the plurality of items.

4. The apparatus according to claim 3, wherein the plurality of items is comprised in the hypertext transfer protocol document, or the hypertext transfer protocol document comprises links to the plurality of items.

5. The apparatus according to claim 1, wherein the at least one indication of gaze comprises a plurality of indications of gaze originating from a plurality of users, and the modifying of the presentation is at least in part based on the plurality of indications of gaze.

6. The apparatus according to claim 5, wherein the at least one memory and the computer program code are configured to, with the at least one processor, further cause the apparatus to compile statistical information from the plurality of indications of gaze and the modifying of the presentation is at least in part based on the statistical information.

7. The apparatus according to claim 6, wherein the modifying of the presentation comprises at least one of increasing prominence of at least one third item that is gazed at more than a fourth item and decreasing prominence of at least one fifth item that is gazed at less than a sixth item.

8. The apparatus according to claim 6, wherein the modifying of the presentation comprises selecting a text element to be read by a machine vocalizer.

9. The apparatus according to claim 1, wherein the apparatus is further configured to request the at least one indication of user gaze from a web service, the at least one indication of user gaze comprising information on a plurality of user gazes, to select a text from a multimedia document based at least in part on the information, and to cause the presentation of the selected text to be performed by causing the selected text to be provided to a machine vocalizer.

10. A method comprising:
receiving at least one indication of user gaze, and
based at least in part on the at least one indication of user gaze, cause a presentation of at least one item comprised in a plurality of items to be modified or performed.

11. The method according to claim 10, wherein the modifying of the presentation comprises at least one of modifying a visual size of the at least one item, modifying an order of presentation, modifying an audio presentation of the at least one item and suppressing presentation of the at least one item.

12. The method according to claim 10, wherein the modifying of the presentation comprises modifying a hypertext transfer protocol document to at least one of increase prominence of a first item among the plurality of items and decrease prominence of a second item among the plurality of items.

13. The method according to claim 12, wherein the plurality of items is comprised in the hypertext transfer protocol document, or the hypertext transfer protocol document comprises links to the plurality of items.

14. The method according to claim 10, wherein the at least one indication of gaze comprises a plurality of indications of gaze originating from a plurality of users, and the modifying of the presentation is at least in part based on the plurality of indications of gaze.

15. The method according to claim 14, further comprising compiling statistical information from the plurality of indications of gaze and the modifying of the presentation is at least in part based on the statistical information.

16. The method according to claim 15, wherein the modifying of the presentation comprises at least one of increasing prominence of at least one third item that is gazed at more than a fourth item and decreasing prominence of at least one fifth item that is gazed at less than a sixth item.

17. The method according to claim 10, wherein the modifying of the presentation comprises selecting a text element to be read by a machine vocalizer.

18. The method according to claim 10, further comprising requesting the at least one indication of user gaze from a web service, the at least one indication of user gaze comprising information on a plurality of user gazes, selecting a text from a multimedia document based at least in part on the information, and causing the presentation of the selected text to be performed by causing the selected text to be provided to a machine vocalizer.

19. (canceled)

20. (canceled)

21. A non-transitory computer readable medium having stored thereon a set of computer readable instructions that, when executed by at least one processor, cause an apparatus to at least:
receive at least one indication of user gaze, and
cause, based at least in part on the at least one indication of user gaze, a presentation of at least one item comprised in a plurality of items to be modified or performed.
